(19) United States
(12) Patent Application Publication
(10) Pub. No.: US 2019/0050787 A1
(43) Pub. Date: Feb. 14, 2019

(54) RIDER MATCHING IN RIDESHARING

(71) Applicant: Intel Corporation, Santa Clara, CA (US)

(72) Inventors: Tamir Damian MUNAFO, Naale (IL); Dagan ESHAR, Tel Aviv-Yafo (IL); Shachar OZ, Haifa (IL)

(21) Appl. No.: 15/860,715

(22) Filed: Jan. 3, 2018

(51) Int. Cl. G06Q 10/06; G06Q 50/30; G06N 99/00; G05D 1/00; G05D 1/02

(52) U.S. Cl. CPC G06Q 10/063118; G06Q 50/30; G06Q 50/01; G05D 1/0088; G05D 1/0291; G06N 99/005

(57) ABSTRACT

Herein is disclosed a ride matching system comprising a memory configured to store a plurality of vehicle identifiers, each vehicle identifier being associated with a geographic information and a passenger factor of a current or planned passenger; one or more processors, configured to receive a user ride request comprising a user locational information and a user factor; and select in response to the user ride request a subset of vehicle identifiers based at least on a relationship between a geographic information and the user locational information and on a relationship between the passenger factor and the user factor.

### TECHNICAL FIELD

Various aspects of the disclosure relate generally to use of multiple dynamic database factors to match riders within an autonomous vehicle.

### BACKGROUND

Various taxi services and ride-hiring systems permit ridesharing, whereby otherwise unrelated passengers may be grouped within the same vehicle to travel to same or similar destinations. Although such ridesharing systems may require one or more extra-stops, or may take an alternative and less direct route to the destination, passengers may be willing to accept these factors because of a reduction in fare or other advantageous condition. Such ridesharing is expected to become more commonplace, particularly as the use of autonomous vehicles increases. Current systems to combine ridesharing passengers within a vehicle rely primarily on traveling information, such as similarity of origin, similarity of destination, or similarity of route. As the sharing of a vehicle with strangers becomes more commonplace, it is desirable to develop additional criteria with which to match prospective passengers.

### SUMMARY

Herein is disclosed a ride matching system including a memory configured to store a plurality of vehicle identifiers, each vehicle identifier being associated with a geographic information and a passenger factor of a current or planned passenger; one or more processors, configured to receive a user ride request including a user locational information and a user factor; and select in response to the user ride request a subset of vehicle identifiers based at least on a relationship between a geographic information and the user locational information and on a relationship between the passenger factor and the user factor.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows a ridesharing system according to an aspect of the disclosure;

FIG. 2 shows a ride request and processing of same;

FIG. 3 shows a machine learning procedure;

FIG. 4 shows a feel of vehicles for a ride request;

FIG. 5 shows a selection of vehicles according to a comparison of a user factor and a passenger factor;

FIG. 6 shows an elimination of non-selected vehicles from the vehicle choices;

FIG. 7 shows a ridesharing selection, wherein the match is selected by both the user and the passenger;

FIG. 8 shows a ridesharing selection, wherein the match is selected only by the user or the passenger;

FIG. 9 shows a user display for selection of a passenger, according to one aspect of the disclosure;

FIG. 10 shows a user factor scale system, according to another aspect of the disclosure;

FIG. 11 shows a ride matching system, according to an aspect of the disclosure;

FIG. 12 shows a sensor configuration, according to an aspect of the disclosure; and

FIG. 13 shows a method of ride matching.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration.” Any aspect of the disclosure described herein as “exemplary” is not necessarily to be construed as preferred or advantageous over other aspects of the disclosure.

Throughout the drawings, it should be noted that like reference numbers are used to depict the same or similar elements, features, and structures.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

Within recent years, the concept of ridesharing has become commonplace. Various taxi systems and ride-hiring programs allow otherwise unrelated passengers to share a vehicle to arrive at a same or similar destination. This may occur, for example, at a ride origin with heavy ride traffic, such as an airport, where many people originate travel to another destination. Where this occurs, passengers traveling to the same or similar destinations, or passengers for whom at least a portion of the route to their destination is the same, may be grouped together within a vehicle as an efficiency and cost saving measure. Many such taxi systems and ride-hiring programs offer a reduced cost to each passenger, when two or more unrelated passengers share a vehicle.

As autonomous vehicles are developed and become more commonplace within the market, it is anticipated that autonomous vehicles will begin offering many of the services currently performed by taxis and ride-hiring programs. That is, autonomous vehicles will be available to transport people from an origin to a destination, much the same way that a taxi would perform the service.

Notably, current ridesharing services group passengers within vehicles based primarily on factors related to travel or locomotion. Such factors may include similarity of origin, similarity of destination and/or similarity of route. When applying these procedures to autonomous vehicles, it is noteworthy that autonomous vehicles lack a driver, which may create both new opportunities and new concerns when matching strangers within a same vehicle. For at least the comfort, safety, and benefit of the passengers, it is desirable to consider additional variables in selecting passengers to share a vehicle within a ridesharing scenario. Accordingly, it is envisioned to additionally match passengers in a ridesharing scenario based on one or more additional profile factors, which may include interests, ride preferences, historical information, social media information, human factors, and the like.

Throughout this disclosure, references repeatedly made to ride negotiations between a person currently in a ridesharing vehicle, and a person seeking to initiate a ride within a ridesharing vehicle. For clarity, the terms “passenger” and “user” have been selected to define these respective positions. That is, “passenger” is used to describe a person located within a ridesharing vehicle and engaged in a ridesharing event, and a “user” is a person seeking to initiate a ridesharing event. The term “rider” is selected where the distinction between user and passenger is diminished or becomes irrelevant, such as describing the user after the user enters the vehicle with the passenger, and therefore both “user” and “passenger” have largely assumed the same roles.

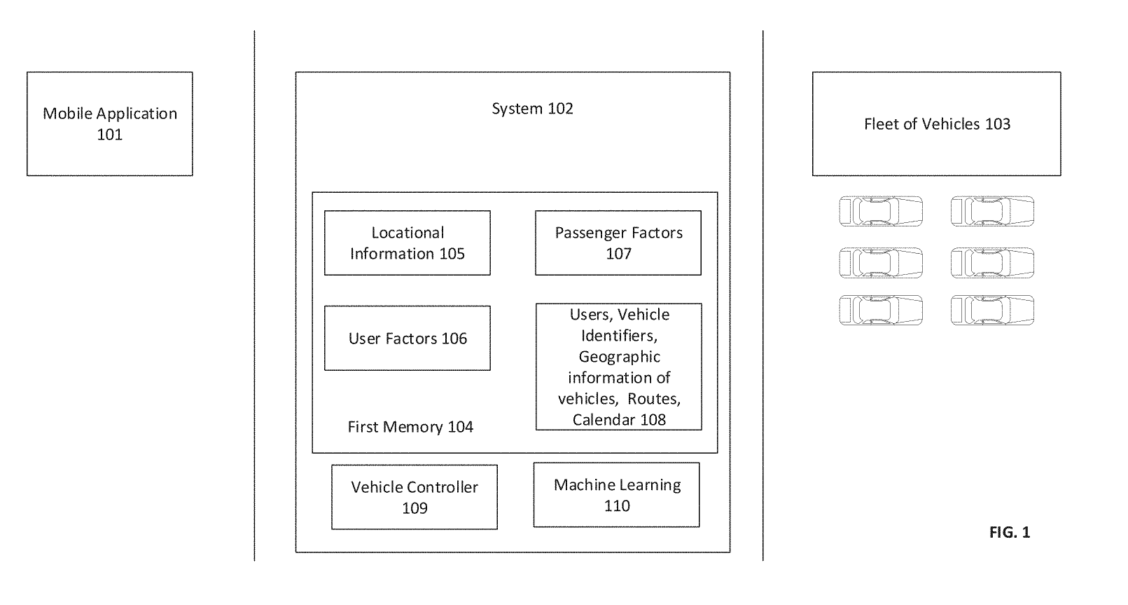

FIG. 1 shows a ridesharing system according to one aspect of the disclosure. In this case, the ridesharing system includes a mobile application 101, a central ridesharing system 102, and a fleet of vehicles 103. The mobile application 101 may be an application configured for use on a mobile device, such as a cell phone or tablet, or on a desktop computer, or any other computing device. As mobile, Internet-ready devices become more common, and particularly with the development of Internet of things technology, it is anticipated that additional devices will become available or practical, and nothing herein should be understood as limiting the mobile application 101 to a cell phone, tablet, or any specific examples mentioned herein. The mobile application 101 may be configured to operate using any computer language, and may be available for purchase or installation via a virtual mobile device store, download, or otherwise. A user may initiate a ride using the mobile application, at least by providing an origin location. The origin location may be a location of the user, or a location where the ride is to begin. The mobile application may be configured with a plurality of data fields describing user interests, preferences, historical information, social media information, human factors, or otherwise. During the ride initiation process, the mobile application 101 contacts the system 102 to evaluate ridesharing possibilities.

The system 102 includes a memory 104, which is configured to store associations between one or more of the following: locational information 105; user factors; 106, passenger factors 107; and information pertaining to users, vehicles, geographic information of vehicles, routes, and calendar 108.

Locational information 105 may pertain to a location or intended location of a user. The locational information may include a current location or a future or expected location. The current location may be provided by direct entry of an address, by positioning system data (such as Global Positioning System), by triangulation or other method of location analysis via a radio access technology, such as LTE, 5G, or otherwise. A future location may be a location other than a current location, where a user intends to begin a ridesharing trip. This may occur where a user intends to travel to a location other than the current location, and to begin a ridesharing trip from that position.

User factors 106 may be any factor associated with a user. User factors 106 may be directly inputed by a user for a specific ride, may be part of a user profile, and/or may be machine learned. User factors 106 will be described herein as including user interests, user preferences, and/or human factors.

With respect to user interests, it may be presumed that users will experience greater ridesharing satisfaction when matched with other riders who share similar interests. For example, it may be desirable to match riders who share similar political beliefs, such as both being liberal or both being conservative. Similarly, it may be desirable to match riders who share similar interests in cultural or pop-cultural offerings, such as music, film, literature, or otherwise. It may be desirable to match riders with similar educational backgrounds or levels. User interests may include any interest category whatsoever including, without limitation, politics, political parties, music, film, literature, sports, religion, education, charitable activities, clubs, food, or otherwise. User interests may further include marital status, interest in dating or relationships, interest in meeting new people, and the like. Users may supply the system with one or more user interests by inputting interest references, answering background questions, or evaluating a range of topics. For example, users may be asked to input information related to a biography or basic background, such as their educational level or area, hobbies, activities, etc. These answers may then be incorporated into the database and stored as user interests within the user factors 106 region. Users may be given a variety of questions to answer or to evaluate, such as on a sliding scale. That is, users may be asked to rate their interest in a variety of topics within a scale, and the results may provide information related to the user interests, and thus stored within the user factors 106 region. The evaluation or inputting of user interests may be performed within the mobile application 101, within a separate profile, or otherwise. Alternatively or additionally, user interests may be obtained or derived from third-party applications, such as social media. According to this aspect of the disclosure, the ridesharing system, including the mobile application 101, system 102, or otherwise, may log into or search a user's social media account or profile to obtain user interest information, such as the topics or activities that the user has “liked”, the activities participated in, topics posted about, and otherwise.

User preferences may be described as any preference the user has for the ride or passenger. With respect to preferences for the ride, the user preferences may include vehicle related preferences, such as type of vehicle, quality of vehicle, cost of vehicle, and/or features of vehicle. The vehicle related preferences may further include comfort factors such as whether the air-conditioner is operated, whether the windows are open or closed, whether seatbelts are worn, whether music is played or other background noise is made available, etc. Ride preferences may also include travel related preferences, such as the route taken, the speed driven, whether highways or roads are utilized, desires to see or avoid certain features or areas, or otherwise. With respect to user preferences related to passengers, users may prefer passengers with similar interests, such that there is an anticipated overlap of commonality or discussion topics available. Users may prefer passengers with differing interests, such as persons with opposing political or religious viewpoints. Users may indicate a desire to converse during the ride or a desire to be silent or engage in silent activities, such as reading, private music listening, or otherwise.

User factors 106 may further include human factors. Such human factors may include the fields of physical ergonomics, cognitive ergonomics, or organizational ergonomics. For example, a user may prefer vehicles offering a particular ergonomic configuration or advantage, or may wish to avoid vehicles offering a particular ergonomic disadvantage. Riders may be matched based on notions of personal space, such as whether they sit close to one another or farther away. Riders may be grouped based on cognitive ergonomic factors, such as perception, memory, reasoning, and/or motor response. They may be grouped based on communication strategies, argumentative strategies, or the like.

Passenger factors 107 may be any factor described herein with respect to user factors 106, but applied to a passenger. Although the terms “user” and “passenger” have been used for clarity, it is anticipated that the distinction between users and passengers is fluid, as a user becomes a passenger upon entering a vehicle, and a passenger becomes a user upon exiting a vehicle and initiating a new ride request. It is anticipated that users and passengers may complete the same profiles and may generally make available the same times of information. It is anticipated that the ridesharing system will have been provided with, or will have assessed, one or more user factors and one or more passenger factors, such that the user factors and passenger factors may be compared to either match riders or to eliminate prospective rider pairings.

The system 102 may further include information about users, vehicle identifiers, geographic information of vehicles, routes, and calendar 108. The user information may include any biographical information of the user, including, but not limited to, name, address, nationality, unique identifier, or otherwise. User information may further include a rating of the user, such that passengers paired with users in previous rides may rate the user, such that the individual rating or a combined average of ratings may be available for future passengers and/or the system. Similarly, a user may be given an opportunity to rate a passenger. By making ratings available, ratings, or the averages of such ratings, may be taken into consideration in matching a user and passenger for a prospective ride, or in permitting a user or passenger to accept a ride with another person.

Vehicle identifiers may be provided for each vehicle, such that the system can identify each vehicle of the fleet, and a unique vehicle identifier is associated at least with a location of the vehicle. The locations of vehicles may be referred to as a geographic information and may be derived from any source whatsoever. According to one aspect of the disclosure, the vehicles within the fleet may be equipped with a GPS module, such that they are able to provide the system upon request, or in real time, with geographic information corresponding to their current position. The database may store route information, such that appropriate routes may be selected for transportation of one or more users and/or one or more passengers within the vehicle. The route data may generally be mapping data and may be stored within the system 102 or be provided from third-party databases, such as commercial searching or mapping systems. Calendar information may be stored, such that vehicles and/or users are associated with times and dates for future rides.

The system may further include a vehicle controller module 109, which is configured to issue orders or instructions to autonomous vehicles, such as orders to carry out travel, including orders for stopping and pickup, orders for stopping and drop off, routing information, timing information, and otherwise. This may be performed according to any autonomous vehicle practice, without limitation.

The system may further include a machine learning module 110, which is configured to perform one or more machine learning algorithms related to a ride and/or a matching of two or more riders. As will be described in greater detail herein, the machine learning module may obtain information from at least user evaluations or one or more sensors within the vehicle.

The system may be configured to connect with one or more of a fleet of vehicles 103. A ridesharing system may include one or more vehicles, which may be referred to as a vehicle fleet. According to one aspect of the disclosure, the vehicles may be autonomous vehicles. The vehicles may operate according to any known autonomous vehicle technology. The vehicles may be equipped with one or more transceivers, configured to receive and send signals and/or instructions for autonomous driving operations.

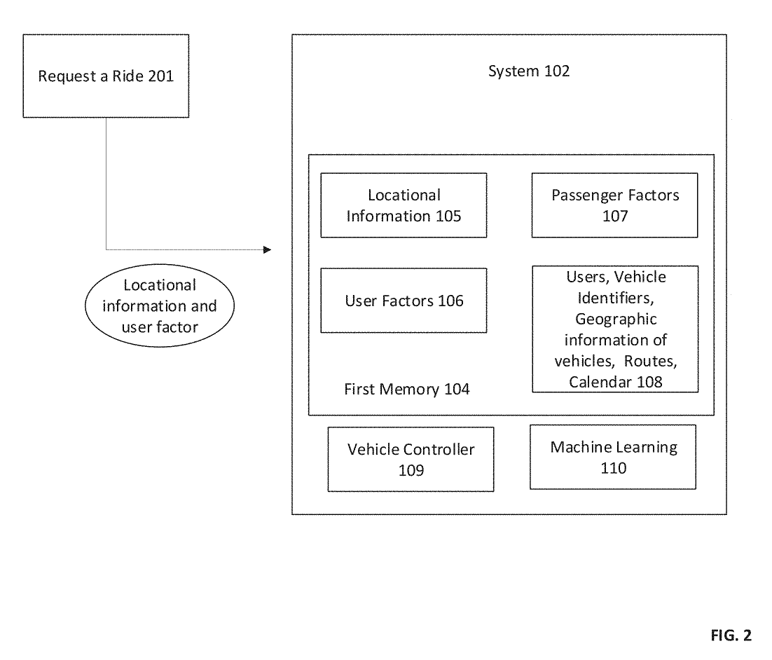

FIG. 2 shows a ride requesting operation, according to one aspect of the disclosure. In this case, a user wishing to request a car sharing ride issues a ride request 201 from the mobile application 101. The ride request may include at least a locational information and a user factor. The ride request is transmitted from the mobile application 101 to the system 102, where it is evaluated in light of other data entries stored within the memory 104. For example, within the vehicle fleet 103, one or more vehicles may be determined to be unavailable, whether due to repair, maintenance, the vehicle operating at full passenger capacity, or otherwise. Such vehicles may be eliminated from consideration for the ridesharing request. Of the remaining vehicles, one or more operations may be performed to match the user locational information with the vehicle geographic information. That is, the vehicles will be assessed for similarity of origin, route, and/or destination. One or more user factors 106 may be compared to one or more passenger factors 107, according to one or more predetermined algorithms, to identify a likely match between a user and passenger. That is, depending on passenger and user preferences, passengers or users may be matched based on similarity or dissimilarity of interests, user and passenger preferences, user and passenger human factors, user and passenger backgrounds, user and passenger ratings, and otherwise. According to one aspect of the disclosure, the user and/or passenger may be provided with a list of one or more persons to share the ride with, corresponding to a subset of available vehicles. That is, a user may be provided with one or more passengers to select for a ride. Similarly, a passenger may be provided with one or more users to select for a ride. These selections may occur substantially simultaneously, or one following the other, such that, for example, a user is provided with a list of potential passengers, and upon selecting a preferred passenger, the preferred passenger is given the opportunity to select or reject the user.

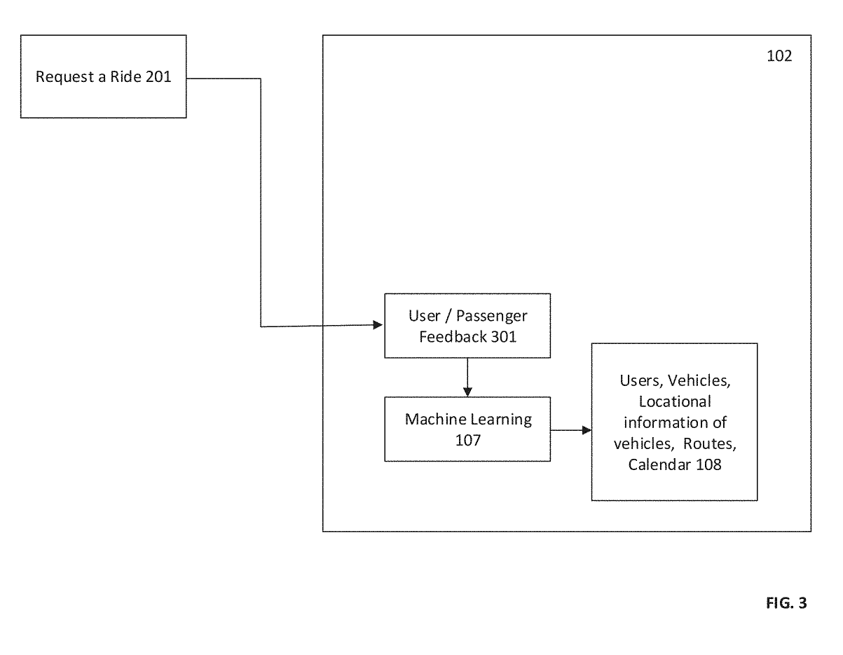

FIG. 3 shows a machine learning procedure according to one aspect of the disclosure. In this case, upon the user requesting a ride 201, and the ride being performed according to the methods described herein, the user and/or passenger may be permitted to provide feedback 301. The feedback may be provided according to any method without limitation, including, but not limited to, numerical ratings, numbers of “stars”, sliding scale ratings, or otherwise. That is, the user and passenger may be allowed to rate one another, the vehicle, and/or the riding experience, and said ratings may be saved for further reference and/or evaluation. A machine learning circuit 107 may assess the ratings to determine a general evaluation of the riding experience, whether positive or negative. Such determinations may be saved within the system memory and/or may be used to modify a user profile. The machine learning circuit 107 may further obtain feedback information from one or more vehicle circuits, as will be described herein. That is, one or more sensors within the vehicle, including, but not limited to, cameras, pressure sensors, motion sensors, and/or microphones, may be used to estimate a general satisfaction level of a user or passenger. The machine learning circuit may equate a general satisfaction level with one or more actions of another rider, and/or with one or more features of the vehicle. Once determined, these actions or vehicle features may be saved within the memory and associated with other data for future reference. The results of the machine learning process may be associated with users, passengers, vehicles, specific locational information, routes, and/or the calendar 108.

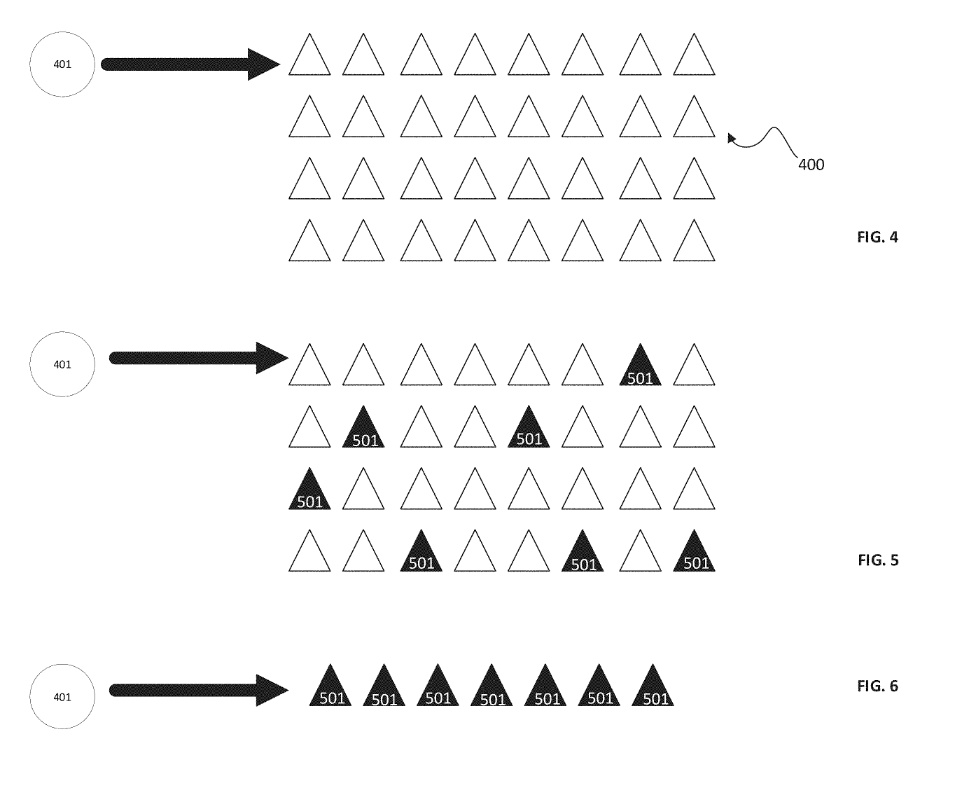

FIG. 4-6 show a selection of a plurality of vehicles within the vehicle fleet pursuant to a ride request. In FIG. 4, a fleet of vehicles 400 is available for ridesharing. A user 401 issues a ride request for a ride within the fleet of vehicles. The ride request includes at least a user locational information and a user factor. The available vehicles 400 within the fleet of vehicles may include one or more passengers, each passenger being associated with one or more passenger factors. The system compares the user factors and passenger factors for likely matching candidates. Similarly, the system may compare user locational information and passenger geographic information to determine a likely match. That is, a passenger is associated with the vehicle in which the passenger is located, and it may be inefficient or undesirable for a passenger or vehicle to be matched with a user, where a distance between the user and passenger is great, or where there is little to no overlap in a selected route. FIG. 5 shows the results of the user factor and passenger factor comparison with respect to the fleet of available vehicles 400. In this case, the comparisons of locational information in geographic information, and of user factors and passenger factors have yielded seven potential vehicles 501 within the vehicle fleet 400, which may be a match. FIG. 6 shows the elimination of undesirable vehicles. That is, a subgroup of the available fleet 400 is formed based on the results of the comparison between at least the user factors and passenger factors. The subset may also result from a comparison of locational information and geographical information.

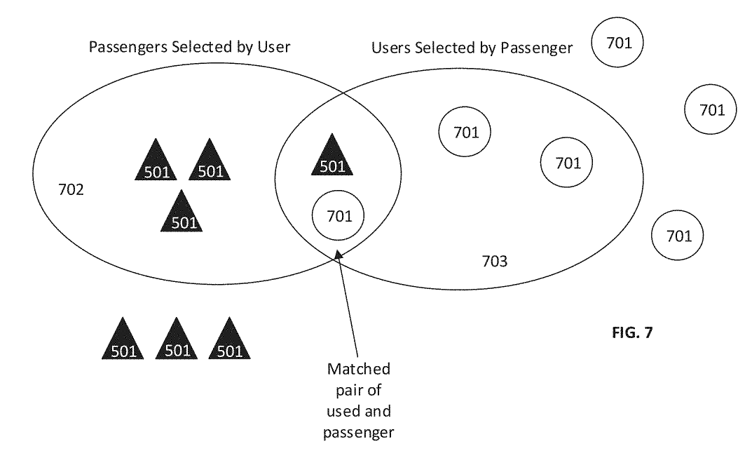

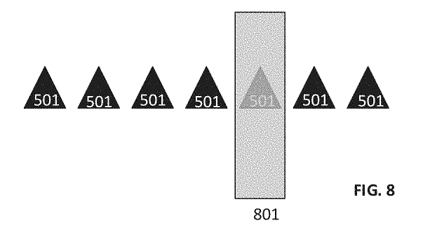

FIG. 7 shows a final matching procedure according to one aspect of the disclosure. According to this aspect, both the user and passenger are provided with a plurality of prospective riders and asked to evaluate the plurality for desirability. In this case, the user has been provided with the seven prospective passengers resulting from the comparisons described above, and is depicted in the triangles labeled as 501. Similarly, a passenger may be presented with a plurality of prospective users, depicted herein as the circles labeled 701. The prospective users may result from a comparison of the passenger factors to a variety of users who have initiated a ride request. The users and passengers are asked to evaluate their respective possibilities. Here, the user has evaluated the seven prospective passengers 501 and group them into four acceptable prospective passengers (as shown by the four prospective passengers grouped within circle 702) and three unacceptable prospective passengers (as shown by the three prospective passengers grouped outside of circle 702). Similarly, the passenger has been provided with six prospective users 701, which the passenger has grouped as three acceptable prospective users (as shown by the three prospective users grouped within circle 703) and three unacceptable prospective users (as shown by the three prospective users grouped outside of circle 703). In this manner, a match is created, because the user and passenger have chosen one another.

Because of the nature of subjective evaluations, several outcomes are possible. First, as in the example above, the evaluations by the user and passenger may result in a single match. Where this occurs, the user may be matched for car sharing with the passenger, and the corresponding vehicle may be instructed to pick up the user. Next, the evaluation results may result in a plurality of matches. For example, a passenger may select two or more users, each of whom select the passenger. Where this occurs, a plurality of matches are possible, and the system must use one or more additional deciding factors to match the user to a passenger. These additional deciding factors may include, but are not limited to, the strength of correlations between user factors and passenger factors, similarity of ratings, or any other criteria desired. It may also occur that no user and no passenger select one another. Where this occurs, the system may be configured to perform a new matching of prospective passengers to a user, or the system may choose a user and passenger who have not selected one another for ridesharing.

FIG. 8 shows a final matching procedure according to another aspect of the disclosure. According to this aspect, upon determination of a subset of prospective passengers for a user ridesharing request, the user is provided with a list of prospective passengers. The list may include one or more details regarding the passengers or the vehicles associated with the passengers. This may include any passenger factor, including passenger interests, passenger preferences, and passenger human factors. When presented with a list of prospective passengers, the user may simply select a desired passenger to complete the match, as shown by 801. In addition to passenger information, the user may be also provided with route, timing, distance information, or the like, such that the passenger is able to weigh these other factors alongside the passenger factors.

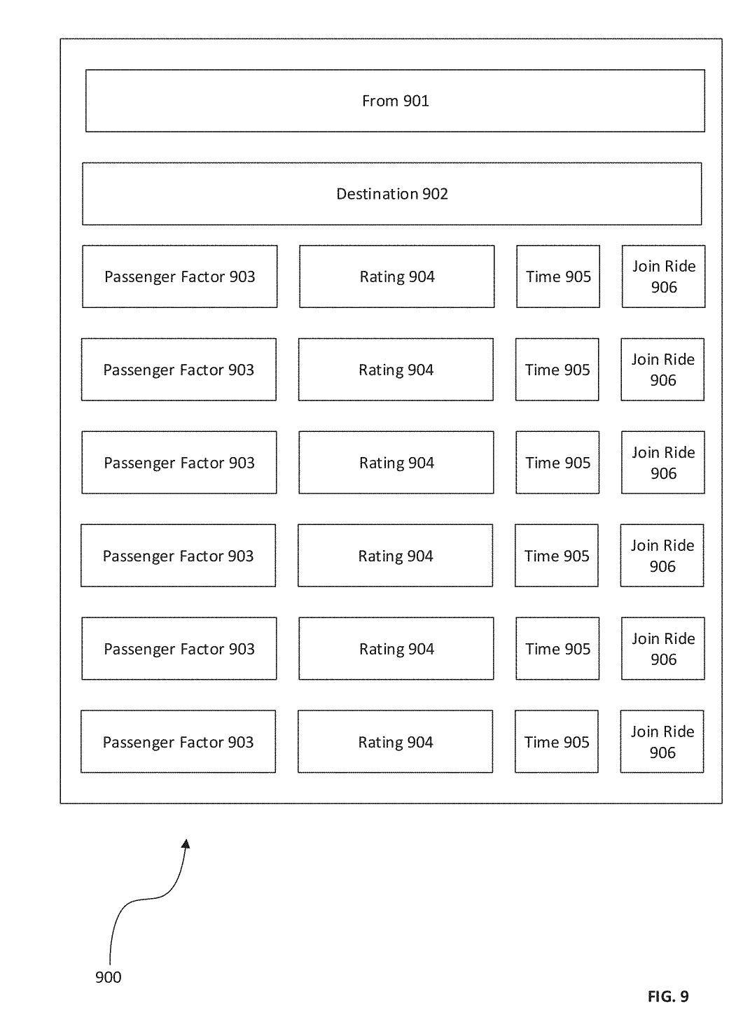

FIG. 9 illustrates a user interface for passenger evaluation and selection, according to an aspect of the disclosure. As described herein, the user interface may be part of a mobile application, or any application on any device, whether mobile or fixed. Through the application, the user may be provided with various categories of information for passenger and/or vehicle of evaluation. The categories provided may differ depending on user preference, system preference, desired implementation, and/or passenger preference. According to the example depicted herein, the user interface 900 displays a user origin 901 and a user destination 902. The user interface 900 additionally displays six prospective passengers, along with various information relating to each passenger. According to this example, each passenger is associated with one or more passenger factors 903, a passenger rating 904, an estimated time of pickup 905, and a button or selection mechanism to select the corresponding passenger/vehicle 906. The corresponding passenger information may include photographs of the passengers. The user interface 900 may further include buttons to chat with, call, and/or videoconference with the prospective passengers. The user interface 900 may further include the ability to access and view a passenger profile from the list of prospective passengers. These methods described herein with respect to user evaluation of passengers may also be applied to passenger evaluation of users. That is, where a plurality of users initiates a ride request, a passenger may be presented with a list of prospective users, and the passenger may be afforded the opportunity to rate and/or select one or more users for ridesharing. This process would be achieved in the same manner as described herein regarding user selection of passengers.

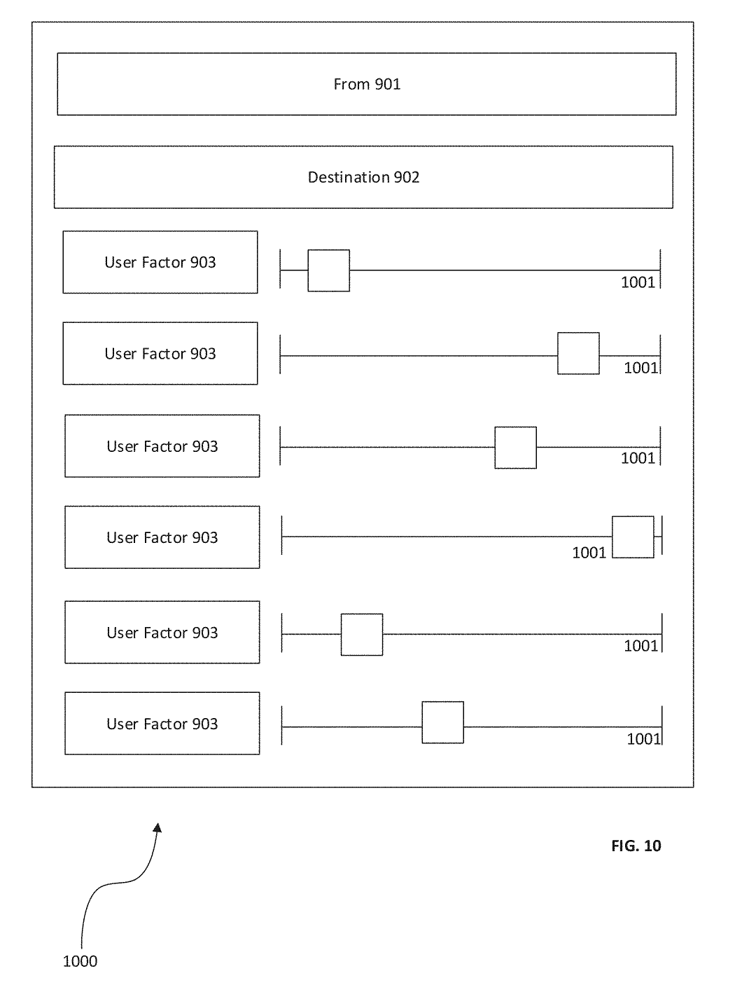

FIG. 10 shows a user factor setting for ride request according to an aspect of the disclosure. In this case, a ride request may be issued by providing one or more of a location of origin 901, a destination 902, and one or more user factors 903. The user factors may be individually inputted by the user or may be copied or selected from a user profile. According to one aspect of the disclosure, the user factors may be associated with the scale 1001, which may permit the user to evaluate the strength of a given user factor with respect to this ride. This configuration takes into account that certain user factors are circumstance-dependent and therefore may be advantageously adjusted on the fly. For example, a user who may normally prefer listening to music during a ride may adjust a noise preference where the user must perform a task during the ride that requires quiet. The scale may be associated with any user factor, without limitation. Similarly, a passenger may be given a comparable adjustable scale to adjust one or more of the passenger factors associated with the passenger. Some or all of the scale information may be exchanged from the user to the passenger and/or from the passenger to the user.

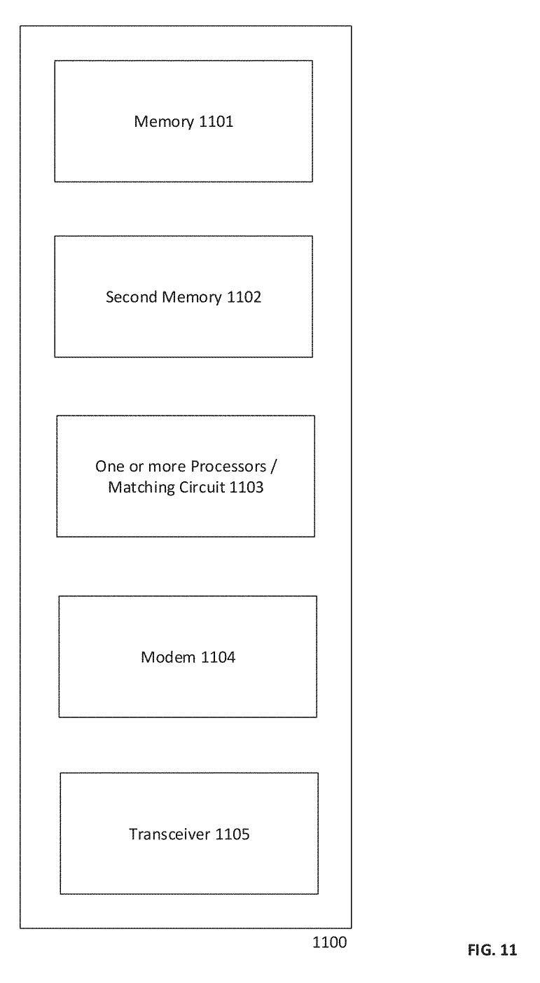

FIG. 11 shows a ride matching system including a memory 1101 configured to store a plurality of vehicle identifiers, each vehicle identifier being associated with a geographic information and a passenger factor of a current or planned passenger; one or more processors 1103, configured to receive a user ride request including a user locational information and a user factor; and select in response to the user ride request a subset of vehicle identifiers based at least on a relationship between a geographic information and the user locational information and on a relationship between the passenger factor and the user factor. The ride matching system may optionally include a second memory 1102, configured to store feedback of a user or a passenger, or one or more user/passenger associations in a non-matching list. Alternatively, this data may be stored in the primary memory 1101. The system may optionally include a modem 1104 to prepare a wireless signal for communication with one or more vehicles and/or one or more wireless devices. The system may optionally include a transceiver 1105 configured to wirelessly transmit a signal between the system and one or more vehicles, and between the system and one or more mobile devices. The second memory, the modem, and the transceiver may be dependent on the desired configuration, and nothing herein should be understood to suggest that these elements are necessary for a unified system.

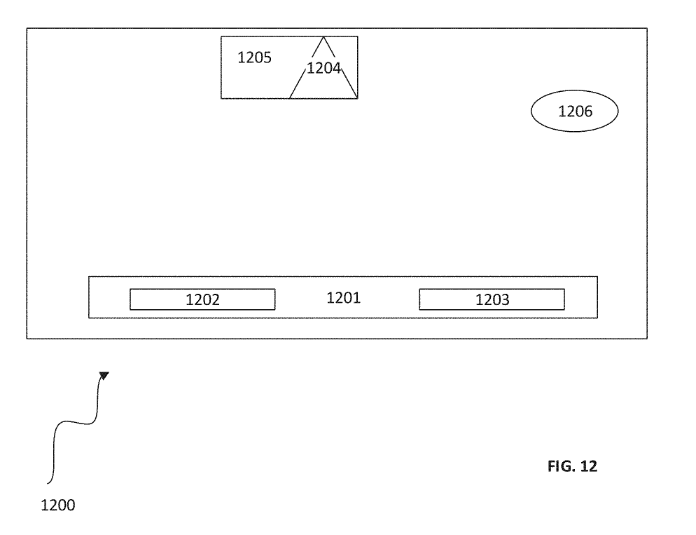

FIG. 12 shows a sensor configuration according to another aspect of the disclosure. One or more vehicles within the fleet of vehicles may be configured with one or more sensors, which are configured to obtain information about the ride and user satisfaction. In this case, an interior compartment of a vehicle within the fleet of automated vehicles is depicted 1200. The rear seat includes a seat bank 1201, into which compression sensors 1202 and 1203 are mounted (although two sensors are depicted in the figure, any number of compression sensors may be used). A camera 1204 is mounted to receive images of the passenger and/or the user. The camera 1204 is connected to one or more processors 1205, which may be configured to perform a variety of assessments on the image data. The vehicle may further be equipped with a microphone 1206 to obtain information about noise levels and speech. According to this configuration, the presence of a user or passenger may be closely associated with activation of a compression sensor 1202 or 1203. The compression sensor will indicate the presence of a person, and the identity of the person can be distinguished from any other persons riding in the vehicle using the camera 1204 data information, which may match user or passenger facial features to corresponding images within the user or passenger profile. Thus, it can be determined the number of people present in the vehicle, and their identities. The camera 1204 may be programmed to deliver image data to the one or more processors 1205 for various computational assessments. These may include, for example, facial recognition, such as identifying a person from a profile or digital image; as well as recognition of facial gestures or body gestures. Certain facial gestures or body gestures are closely tied to emotions or expressions, and a likely mood or emotional expression of the user or passenger may be assessed from the video image data, based on recognized facial gestures or body gestures. Where a likely mood or emotion is ascertained, this information may be incorporated within the user profile and/or a database associated with the user experience. That is, where it is determined that a user experience is unsatisfactory, the unsatisfactory experience may be associated with the passenger, such that the pairing of the user and passenger is not repeated. Furthermore, where the unsatisfactory experience of the user is ascertained, and where a particular condition causing the unsatisfactory experience may be identified within a reasonable likelihood of probability, the user profile and/or a user factor may be updated to better avoid encountering this particular condition in the future. Similarly, the vehicle may be equipped with a microphone 1206, which may be capable of obtaining audio information from within the vehicle. The audio information may be assessed for volume, such as silence, quiet talking, loud talking, or yelling. The audio information may further be assessed for speech recognition. The audio data may be sent to one or more processors, either located within the vehicle, within the system, or within an external third-party, to evaluate the audio data to identify speech content and/or likely emotions associated with the audio data. In the same way that facial gestures and body gestures may be associated with emotions to update a user profile or data associated with the user, passenger, or ride, so too can these data areas be updated by the results of the audio analysis.

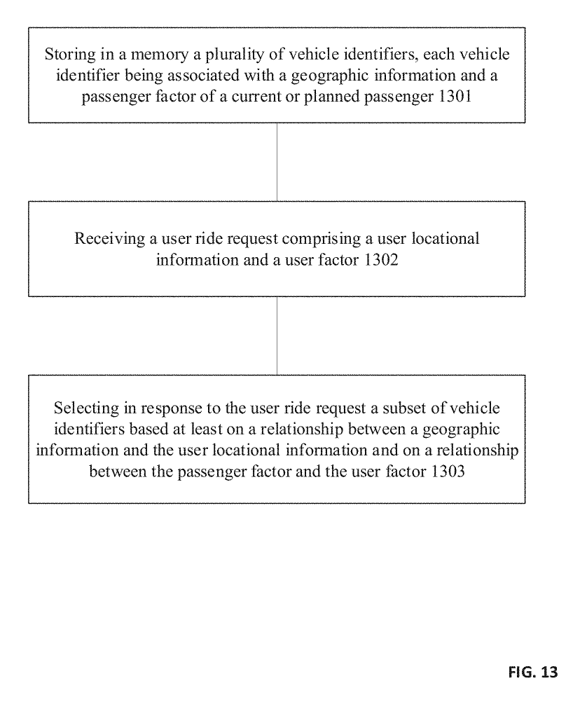

FIG. 13 shows a method for ride matching including storing in a memory a plurality of vehicle identifiers, each vehicle identifier being associated with a geographic information and a passenger factor of a current or planned passenger 1301; receiving a user ride request including a user locational information and a user factor 1302; and selecting in response to the user ride request a subset of vehicle identifiers based at least on a relationship between a geographic information and the user locational information and on a relationship between the passenger factor and the user factor 1303.

The sensor data taken from the vehicle may be used to activate an alert circuit. That is, the alert circuit may be configured to assess sensor data for irregularities, and may activate one or more alerts when irregularities are determined. This may be of particular significance in an autonomous vehicle situation, where the actions of the riders, as well as the riders' safety with respect to third parties, cannot be evaluated by a driver. For example, the alert circuit may be configured to assess sensor data to determine when the user and/or passenger exits the vehicle. For example, where the user is scheduled to exit the vehicle first, and the passenger is scheduled to exit the vehicle later, if both the user and passenger exit at the same time, this may be an irregularity, and an alert may be activated. Moreover, if the user and passenger are the only two persons scheduled for inclusion within the vehicle, and if a third party opens the door and boards, this may be an irregularity that triggers an alert. Moreover, the sensors and corresponding processors may be configured to detect arguments, fights, or illegal activity, which may be registered appropriately. According to one aspect of the disclosure, a user profile may include contact information for an emergency contact or next of kin, who may be notified of the irregularity when an alert is triggered. According to another aspect of the disclosure, the alert circuit may be configured to call the police, a municipality, an ambulance, a system operator, or otherwise, upon the detection of an irregularity.

According to one aspect of the disclosure, the ride matching procedures described herein may be applicable to one or more autonomous driving vehicles. Nevertheless, nothing in this disclosure should be understood as limiting the principles described herein to autonomous driving vehicles, and the methods and procedures described herein may equally be applied to driver-operated vehicles. That is, where ridesharing is available within driver-operated vehicles, the principles described herein, including but not limited to matching a user and a passenger based at least on a user factor or a passenger factor, may be utilized in a driver-operated vehicle scenario.

The system may include a database that is configured to associate various data points of different categories in a ridesharing context. For example, a database for a fleet of autonomous vehicles may include a vehicle identifier for each of the autonomous vehicles, as well as a geographic information corresponding to a current location of the vehicle, or a planned, future location of a vehicle. The geographic information may be updated in real time based on a wireless transfer of information, whether directly or indirectly, between a vehicle and the system. The geographic information may be periodically updated, such as every minute, five minutes, ten minutes, or hour. The geographic information may include a future location associated with a time, such as a planned pickup point, drop-off point, or anticipated location during a planned route at a particular time.

A passenger factor may be any factor associated with the passenger. The passenger factor may be described in terms of a passenger interest, a passenger preference, or a passenger human factor. According to one example, the passenger preference may be a noise preference, such as a preference for background music, a preference for silence, or otherwise. The preference may be broadly listed, such as a preference for “loud” or “quiet”, or may be listed with any amount of specificity, such as a preference for a particular radio station, musician, song, program, or conversational topic.

The user factor and passenger factor may be a user interest or a passenger interest. The interest may be anything whatsoever that interests the user or passenger. The interest may be useful to develop commonly acceptable, or even suggested, areas of conversation. That is, a user and passenger both interested in a particular topic may be matched due to their interest in the topic. Their common interest in the topic may be made known to the user, the passenger, or both. Having identified a common interest, the system may optionally notify one or both users of the common interest and/or suggest the common interest as a conversational topic.

The user factor and passenger factor may be a service offered by the user or passenger. The user and passenger may be matched based upon the offering of the service and a desire for that service. For example, a passenger may offer foreign language lessons during a ride. A user, being informed of a prospective passenger's offering foreign language lessons, may select that passenger based on the offered service. The variety of services offered is essentially unlimited and may include any service, including, but not limited to, foreign languages, tutoring, training, therapy, or otherwise.

The user factor and passenger factor may be inputted by the user and passenger respectively, or may be obtained from an outside source, such as a social media account. That is, a user seeking to use the ridesharing service may establish a user profile including one or more user factors. Rather than, or in addition to, answering questions about the user's interests and preferences, the user may provide the system with login information for one or more social media accounts. The system may be configured to log into the user's social media account and obtained from the data therein information pertaining to user interest, user preference, or user human factors. The system may include one or more processors that are configured to assess social media data and, using one or more algorithms, derived from said social media data one or more interests, preferences, or human factors to be associated with a user or user's profile. The system may update or modify a user profile in accordance with the social media information.

The user factor or passenger factor may be a factor associated with the user or passenger based on one or more prior rides. At the conclusion of each ride, the user and passenger may be asked to evaluate one another. The results of this evaluation may be saved within the user or passenger profile and made available for other prospective riders. The data may become publicly available. Moreover, during the course of a ride, the system may be configured to assess one or more behaviors or preferences of the user or passenger, to store this information, and to associate this information with the corresponding user or passenger. That is, where, for example, music is playing loudly, and a user exhibits physical characteristics associated with discomfort, it may be determined that the user should preferably be matched with persons who wish to maintain quiet during a ride. By incorporating observed or computer-determined data from a ride, the user profile and/or a database of information associated with the user profile may be updated to provide more accurate matching results.

The system may include a machine learning circuit, which is configured to execute one or more machine learning algorithms using at least data obtained from user or passenger evaluations, or sensor data during a ride. At the conclusion of a ride, the passenger and/or the user may be asked to evaluate one or more riders within the car. The machine learning circuit may be configured to evaluate the rider evaluations according to one or more machine learning algorithms and thereby to reach machine learning conclusions. Such conclusions may be used to modify or update a user profile. For example, such machine learning conclusions may indicate a stronger preference for a user factor then inputted by the user. Accordingly, the user profile may be updated to correspond to the conclusion reached by the machine learning algorithm. Moreover, the machine learning module may perform machine learning exercises based on received sensor data. The received sensor data may indicate a level of user satisfaction. The machine learning module may be programmed to correlate a level of user satisfaction with one or more factors or characteristics of the ride. For example, where a user appeared satisfied with the ride until a window was opened, and the user then appeared dissatisfied with the ride until the window was closed, it may be concluded that the user prefers to ride with the windows closed. This information may be stored in the users' profile, used to update or modify a user profile, or otherwise stored in a memory and associated with the user. The computer learning module may be configured to receive information from any variety of sensors without limitation, including, but not limited to, one or more pressure sensors, one or more seatbelt sensors, one or more image sensors, one or more motion detectors, one or more microphones, and otherwise.

The system may include an additional memory or an additional database association to include information gathered from one or more prior rides for inclusion in a user and passenger matching operation. This associated data may be separate from the user profile. The associated data may conflict with the user profile, such as where one or more observed tendencies, interests, or preferences of a user contradict one or more user-inputted tendencies, interests, or preferences. This information may be weighted with respect to the user-inputted information according to any desired weighting scheme. That is, information derived from vehicle sensors or otherwise derived by the system may be disregarded when said information conflicts with user-inputted preferences; it may be given priority over any conflicting user-inputted information; or it may be weighted such that both the derived information and user-inputted information are considered for ride matching.

A user locational information may include a current user location, an anticipated user location for pickup, and/or a user destination or ride termination. It is anticipated that a user location for an origin of a ride is necessary, such that the vehicle in one location may be matched to a user in another location.

Although a user destination may be typically included, such that a user can be brought to a desired location, a destination may not be necessary. According to one aspect of the disclosure, a user may not seek to be transported to a specific destination, or the destination may be largely irrelevant. That is, the user may seek a ridesharing ride based on content or experience available during the ride rather than on transportation from a first location to a second location. This may occur, for example, due to a service offered by a passenger, such as lessons, training, or the like. This may similarly occur where a purpose of the ridesharing is to establish an encounter between two or more people. Where this occurs, the user may participate in a ridesharing ride for the purpose of being present with the passenger, rather than the purpose of transportation. The end destination of such a ride may be largely irrelevant, or the ride it may be configured to return the user to the point of ride origin.

Throughout this disclosure, various data points have been described as being stored in memory and associated with one another. Said memory storage and association may be performed according to any known method of data management, whether in a database format, or otherwise. Said data may be stored in one or more tables, one or more associated lists, one or more matrices, or otherwise.

The user ride request may be initiated from a mobile device. The mobile device may be any device capable of producing a ride request, without limitation, including, but not limited to a mobile phone, a handheld organizer, a tablet, a notebook computer, a laptop computer, an Internet enabled watch, a motor vehicle, a kiosk, a desktop computer, a wearable device, and Internet of things enabled device, or otherwise.

Where sensor data is received by the system, the system may employ one or more additional technologies to interpret the sensor data. According to one aspect of the disclosure, the system may employ a facial recognition technology to analyze and interpret facial responses of one or more riders. Such technology may permit analysis of mouth shape or position, eye direction or position, or other facial features to assess the likelihood of a given facial expression and/or corresponding emotion. Similarly, the system may utilize voice recognition software, which may be configured to identify a speaker within the vehicle associated with a particular recorded segment, and to decipher and interpret the words being spoken. The system may be configured to recognize words, speech characteristics, sentences, or sentence structures and associate them with emotional or situational responses. Such responses may be used to modify a profile or to store data regarding a relationship between the riders.

The system may be further configured with an alert circuit, the alert circuit being configured to recognize a ride irregularity and provide a corresponding alert notification. The alert circuit may be capable of receiving data from one or more sensors and assessing the sensor data to determine the presence of an irregularity. Such irregularities may include, without limitation, a rider leaving the vehicle at an unexpected location; an unexpected person entering the vehicle; a physical encounter between two or more riders; a volume level consistent with an altercation or argument; a word or phrase consistent with an altercation or argument, or otherwise. The vehicle may be equipped with one or more sensors capable of ascertaining a vital sign, such as body temperature, heart rate, or respiration. The system may be configured to derive an irregularity of a vital sign and produce a corresponding alert notification based on any of the foregoing conditions occurring, ceasing, or changing within a predetermined threshold. An alert notification may be a notification to one or more riders, to one or more emergency contacts of a rider, a system operator, a police department, an emergency response team, and ambulance, or otherwise.

The one or more processors may be configured to transmit a subset of vehicle identifiers to the user and/or the passenger. The vehicle identifiers may be associated with information corresponding to one or more other riders, such as a profile, interest, preference, or human factor. The subset may be a subset of vehicle identifiers after eliminating any unavailable vehicles, and after performing a search to match a user with one or more passengers as described herein.

The memory may include associations of riders who have opted not to ride together. For example, after a ride is completed, the user and passenger may be given an opportunity to evaluate one another. Where one or more of the parties provides a negative evaluation to the other, the user and passenger may be stored in a “non-matching” list, whereby the user and passenger will not be matched for future rides within the same vehicle. This may be part of a separate list, or it may be an association within a primary list or database. Furthermore, where a user has been presented with a passenger as an option for ridesharing, and where the user has once or repeatedly chosen not to share a ride with the passenger, the machine learning circuit may determined that the user does not wish to engage in a ride with the passenger, and the passenger may be omitted from future searches. That is, the passenger may not be presented within the subset, and the user may not be given the option of selecting the passenger in the future.

Each user may use a mobile application to input transportation information, including starting point, destination, and/or schedule. The system may store an updated user model with a data matrix grading each metric. It may feed both explicitly (manual input) and implicitly (from multiple sensors and technologies). The system may match people that share mutual interests and preferences, and cause an autonomous vehicle to drive along a common path. The passenger match maker (one or more processors) may narrow down the list of available vehicles to those that have passengers with matching preferences. That data will be then calculated inside path finder (route), to provide user with optional routes, time to destination, themes and ride features. The user and passenger matching may be achieved based on profile information and/or learned user preferences. The system may apply a similarity metric between users and/or passengers, and grade the similarity of all the candidate users and/or passengers. Users and/or passengers with similarity grade above a certain threshold are considered for sharing a ride. The threshold can be also part of the user's or passenger's preferences. Once a list of potential matches is created and delivered to the user, the user selects a preferred ride. When a ride is selected, all users and passengers may be notified. The system updates the ride's itinerary on the route calendar. The vehicle arrives at selected time and pickup location.

According to one aspect of the disclosure, the user profile may include one or more media system preferences, such as radio, TV, movies, etc. The In-Vehicle Media System may be synced with the user's preferences and ride settings to display content congruent with a user's preferences.

Taxi arrives at selected time and pickup location. The In-Vehicle Media System is synced with the user's preferences and ride settings.

Further examples of user factors may include personality aspects such as whether the user is a loner, people person, creative, etc; hobbies, such as whether the user enjoys soccer, cooking, coding, makers, movies, mechanic, etc.; interests, such as whether the user is interested in technology, innovation, crafting, finances, photography, etc.; resume or career attributes, such as the user's work places, projects, education; significant locations, such as the user's work place, home, kids' schools, parents' house, etc.; ride preferences, such as speed, fun, preferred routes, pickup spots, etc.; and media preferences, such as favorite media, volume, genres, etc.

The system may receive input for decision making and/or profile modification from natural language processing. The natural language processing may be assessed to detect a quality of conversation, such as whether a conversation between riders is successful. Gesture recognition and behavioral understanding may be performed through the use of a camera as described herein.

The routing component is responsible for providing possible routes. It may be locally saved or stored on a cloud. It obtains information from the passenger match maker (described herein as the “one or more processors”) and the vehicle controller, which may be configured to provide a list of available and validated vehicles nearby, whether they are already operating a ride or not.

Any example of the ride matching system as disclosed herein may be configured as a circuit, a module, an apparatus, or a device.

The following examples pertain to various aspects of the disclosure as described herein:

In Example 1, a ride matching system comprising a memory configured to store a plurality of vehicle identifiers, each vehicle identifier being associated with a geographic information and a passenger factor of a current or planned passenger; one or more processors, configured to receive a user ride request comprising a user locational information and a user factor; and select in response to the user ride request a subset of vehicle identifiers based at least on a relationship between a geographic information and the user locational information and on a relationship between the passenger factor and the user factor.

In Example 2, the ride matching system of Example 1 is disclosed, wherein the vehicle identifiers correspond to autonomous driving vehicles.

In Example 3, the ride matching system of Example 1 or 2 is disclosed, wherein the geographic information is a current location of a vehicle corresponding to the vehicle identifier.

In Example 4, the ride matching system of Example 1 or 2 is disclosed, wherein the geographic information is a planned destination of a vehicle corresponding to the vehicle identifier.

In Example 5, the ride matching system of any one of Examples 1 to 4 is disclosed, wherein the geographic information corresponds to a vehicle route.

In Example 6, the ride matching system of any one of Examples 1 to 5 is disclosed, wherein the passenger factor is a passenger noise preference.

In Example 7, the ride matching system of any one of Examples 1 to 5 is disclosed, wherein the passenger factor is a passenger interest.

In Example 8, the ride matching system of any one of Examples 1 to 5 is disclosed, wherein the passenger factor is a passenger service offered for other passengers.

In Example 9, the ride matching system of any one of Examples 1 to 5 is disclosed, wherein the passenger factor is a factor associated with a social media account of a passenger.

In Example 10, the ride matching system of any one of Examples 1 to 5 is disclosed, wherein the passenger factor is a factor associated with a passenger based on one or more prior rides.

In Example 11, the ride matching system of any one of Examples 1 to 10 is disclosed, wherein the locational information is a user ride origin.

In Example 12, the ride matching system of any one of Examples 1 to 10 is disclosed, wherein the locational information is a user ride termination.

In Example 13, the ride matching system of any one of Examples 1 to 10 is disclosed, wherein the locational information comprises a location between a user ride origin and a user ride termination.

In Example 14, the ride matching system of any one of Examples 1 to 13 is disclosed, wherein the user factor comprises a user noise preference.

In Example 15, the ride matching system of any one of Examples 1 to 14 is disclosed, wherein the user factor comprises a user interest.

In Example 16, the ride matching system of any one of Examples 1 to 15 is disclosed, wherein the user factor comprises a passenger service desired.

In Example 17, the ride matching system of any one of Examples 1 to 16 is disclosed, wherein the user factor comprises a factor associated with a social media account of the user.

In Example 18, the ride matching system of any one of Examples 1 to 17 is disclosed, wherein the user factor comprises a factor associated with a user based on one or more prior rides.

In Example 19, the ride matching system of any one of Examples 1 to 18 is disclosed, wherein the memory is configured as a database.

In Example 20, the ride matching system of any one of Examples 1 to 19 is disclosed, wherein the user ride request is received from a mobile device.

In Example 21, the ride matching system of any one of Examples 1 to 20 is disclosed, further comprising a machine learning circuit, configured to modify a user profile according to a sensor information.

In Example 22, the ride matching system of Example 21 is disclosed, wherein the machine learning circuit receives the sensor information from one or more sensors.

In Example 23, the ride matching system of Example 21 or 22 is disclosed, wherein the sensor information is determined from a vehicle volume level during the ride.

In Example 24, the ride matching system of Example 21 or 22 is disclosed, wherein the sensor information is determined from a window position during the ride.

In Example 25, the ride matching system of Example 21 or 22 is disclosed, wherein the sensor information is determined based on one or more of a seat-belt sensor, a motion detector, or a pressure sensor.

In Example 26, the ride matching system of Example 21 or 22 is disclosed, wherein the sensor information is obtained from a vehicle camera.

In Example 27, the ride matching system of Example 26 is disclosed, wherein data from the vehicle camera is processed using facial recognition technology, and the sensor information comprises a recognized facial characteristic.

In Example 28, the ride matching system of any one of Examples 21 to 27 is disclosed, further comprising selecting the subset based at least on the modified user profile.

In Example 29, the ride matching system of any one of Examples 1 to 28 is disclosed, further comprising an alert circuit, configured to contact a third-party in response to a ride irregularity.

In Example 30, the ride matching system of Example 29 is disclosed, wherein the ride irregularity is an unexpected person entering a vehicle with the user.

In Example 31, the ride matching system of Example 29 is disclosed, wherein the ride irregularity is the user or the passenger exiting the vehicle at an unexpected location.

In Example 32, the ride matching system of Example 29 is disclosed, wherein the ride irregularity is based on a recognized facial characteristic as determined by a facial recognition technology.

In Example 33, the ride matching system of any one of Examples 29 to 32 is disclosed, wherein the third-party is any one of an emergency contact of the passenger, an emergency contact of the user, or a police department.

In Example 34, the ride matching system of any one of Examples 1 to 33 is disclosed, wherein the one or more processors is further configured to transmit the subset of vehicle identifiers to the user.

In Example 35, the ride matching system of any one of Examples 1 to 33 is disclosed, wherein the one or more processors is further configured to transmit information corresponding to the subset of vehicle identifiers to the user.

In Example 36, the ride matching system of Example 35 is disclosed, wherein the one or more processors is further configured to receive a user selection of an information corresponding to the subset of vehicle identifiers.

In Example 37, the ride matching system of any one of Examples 1 to 36 is disclosed, wherein the one or more processors is further configured to instruct a vehicle corresponding to vehicle identifier within the subset to pick up the user.

In Example 38, the ride matching system of any one of Examples 1 to 37 is disclosed, wherein the memory is first configured to store an association of persons who have opted not to ride together is disclosed, wherein the one or more processors are further configured to eliminate from the subset any vehicle identifier corresponding to a user and passenger associated within the memory.

In Example 39, the ride matching system of any one of Examples 1 to 38 is disclosed, wherein the one or more processors are further configured to cause a user identity information to be sent to the current or planned passenger.

In Example 40, the ride matching system of Example 39 is disclosed, wherein the one or more processors are further configured to receive a response from the current or planned passenger, and to eliminate one or more vehicle identifiers from the subset based on the response.

In Example 41, the ride matching system of any one of Examples 1 to 40 is disclosed, wherein the passenger factor includes an evaluation of the current or planned passenger during a previous ride.

In Example 42, the ride matching system of any one of Examples 1 to 41 is disclosed, wherein the one or more processors is further configured to transmit a plurality of potential users for ridesharing to the passenger.

In Example 43, the ride matching system of Example 42 is disclosed, wherein the one or more processors is further configured to receive a passenger selection of an information corresponding to the plurality of potential users.

In Example 44, the ride matching system of any one of Examples 1 to 43 is disclosed, wherein the one or more processors is further configured to receive a user evaluation of the passenger and store a result of the evaluation.

In Example 45, the ride matching system of any one of Examples 1 to 43 is disclosed, wherein the one or more processors is further configured to receive a passenger evaluation of the user and store a result of the evaluation.

In Example 46, the ride matching system of Example 44 or 45 is disclosed, further comprising modifying a user factor or based on a result of the evaluation.

In Example 47, the ride matching system of Example 44 or 45 is disclosed, further comprising modifying a passenger factor or based on a result of the evaluation.

In Example 48, a method for ride matching is disclosed comprising: storing in a memory a plurality of vehicle identifiers, each vehicle identifier being associated with a geographic information and a passenger factor of a current or planned passenger; receiving a user ride request comprising a user locational information and a user factor; and selecting in response to the user ride request a subset of vehicle identifiers based at least on a relationship between a geographic information and the user locational information and on a relationship between the passenger factor and the user factor.

In Example 49, the method for ride matching of Example 47 is disclosed, wherein the vehicle identifiers correspond to autonomous driving vehicles.

In Example 50, the method for ride matching of Example 47 or 48 is disclosed, wherein the geographic information is a current location of a vehicle corresponding to the vehicle identifier.

In Example 51, the method for ride matching of Example 47 or 48 is disclosed, wherein the geographic information is a planned destination of a vehicle corresponding to the vehicle identifier.

In Example 52, the method for ride matching of any one of Examples 48 to 51 is disclosed, wherein the geographic information corresponds to a vehicle route.

In Example 53, the method for ride matching of any one of Examples 48 to 52 is disclosed, wherein the passenger factor is a passenger noise preference.

In Example 54, the method for ride matching of any one of Examples 48 to 52 is disclosed, wherein the passenger factor is a passenger interest.

In Example 55, the method for ride matching of any one of Examples 48 to 52 is disclosed, wherein the passenger factor is a passenger service offered for other passengers.

In Example 56, the method for ride matching of any one of Examples 48 to 52 is disclosed, wherein the passenger factor is a factor associated with a social media account of a passenger.

In Example 57, the method for ride matching of any one of Examples 48 to 52 is disclosed, wherein the passenger factor is a factor associated with a passenger based on one or more prior rides.

In Example 58, the method for ride matching of any one of Examples 48 to 57 is disclosed, wherein the locational information is a user ride origin.

In Example 59, the method for ride matching of any one of Examples 48 to 57 is disclosed, wherein the locational information is a user ride termination.

In Example 60, the method for ride matching of any one of Examples 48 to 57 is disclosed, wherein the locational information comprises a location between a user ride origin and a user ride termination.

In Example 61, the method for ride matching of any one of Examples 48 to 60 is disclosed, wherein the user factor comprises a user noise preference.

In Example 62, the method for ride matching of any one of Examples 48 to 61 is disclosed, wherein the user factor comprises a user interest.

In Example 63, the method for ride matching of any one of Examples 48 to 62 is disclosed, wherein the user factor comprises a passenger service desired.

In Example 64, the method for ride matching of any one of Examples 48 to 63 is disclosed, wherein the user factor comprises a factor associated with a social media account of the user.

In Example 65, the method for ride matching of any one of Examples 48 to 64 is disclosed, wherein the user factor comprises a factor associated with a user based on one or more prior rides.

In Example 66, the method for ride matching of any one of Examples 48 to 65 is disclosed, wherein the memory is configured as a database.

In Example 67, the method for ride matching of any one of Examples 48 to 66 is disclosed, wherein the user ride request is received from a mobile device.

In Example 68, the method for ride matching of any one of Examples 48 to 67, modifying a user profile according to a sensor information.

In Example 69, the method for ride matching of Example 68 is disclosed, wherein the used profile is modified according to sensor information received from one or more vehicle sensors.

In Example 70, the method for ride matching of Example 68 or 69 is disclosed, wherein the sensor information is determined from a vehicle volume level during the ride.

In Example 71, the method for ride matching of Example 68 or 69 is disclosed, wherein the sensor information is determined from a window position during the ride.

In Example 72, the method for ride matching of Example 68 or 69 is disclosed, wherein the sensor information is determined based on one or more of a seat-belt sensor, a motion detector, or a pressure sensor.

In Example 73, the method for ride matching of Example 68 or 69 is disclosed, wherein the sensor information is obtained from a vehicle camera.

In Example 74, the method for ride matching of Example 73 is disclosed, wherein data from the vehicle camera is processed using facial recognition technology, and the sensor information comprises a recognized facial characteristic.

In Example 75, the method for ride matching of any one of Examples 68 to 74 is disclosed, further comprising selecting the subset based at least on the modified user profile.

In Example 76, the method for ride matching of any one of Examples 48 to 75 is disclosed, further comprising determining a ride-irregularity and contacting a third-party in response to the ride irregularity.

In Example 77, the method for ride matching of Example 76 is disclosed, wherein the ride irregularity is an unexpected person entering a vehicle with the user.

In Example 78, the method for ride matching of Example 76 is disclosed, wherein the ride irregularity is the user or the passenger exiting the vehicle at an unexpected location.

In Example 79, the method for ride matching of Example 76 is disclosed, wherein the ride irregularity is based on a recognized facial characteristic as determined by a facial recognition technology.

In Example 80, the method for ride matching of any one of Examples 76 to 79 is disclosed, wherein the third-party is any one of an emergency contact of the passenger, an emergency contact of the user, or a police department.

In Example 81 the method for ride matching of any one of Examples 48 to 80 is disclosed, further comprising transmitting the subset of vehicle identifiers to the user.

In Example 82, the method for ride matching of any one of Examples 48 to 80 is disclosed, further comprising transmitting information corresponding to the subset of vehicle identifiers to the user.

In Example 83, the method for ride matching of Example 82 is disclosed, further comprising receiving a user selection of an information corresponding to the subset of vehicle identifiers.

In Example 84, the method for ride matching of any one of Examples 48 to 83 is disclosed, further comprising instructing a vehicle corresponding to vehicle identifier within the subset to pick up the user.

In Example 85, the method for ride matching of any one of Examples 48 to 84 is disclosed, further comprising storing an association of persons who have opted not to ride together, and eliminating from the subset any vehicle identifier corresponding to a user and passenger who are associated as having opted not to ride together.

In Example 86, the method for ride matching of any one of Examples 48 to 85 is disclosed, further comprising causing a user identity information to be sent to the current or planned passenger.

In Example 87, the method for ride matching of Example 86 is disclosed, further comprising receiving a response from the current or planned passenger, and eliminating one or more vehicle identifiers from the subset based on the response.

In Example 88, the method for ride matching of any one of Examples 48 to 87 is disclosed, wherein the passenger factor includes an evaluation of the current or planned passenger during a previous ride.

In Example 89, the method for ride matching of any one of Examples 48 to 88 is disclosed, further comprising transmitting a plurality of potential users for ridesharing to the passenger.

In Example 90, the method for ride matching of Example 89 is disclosed, further comprising receiving a passenger selection of an information corresponding to the plurality of potential users.

In Example 91, the method for ride matching of any one of Examples 48 to 90 is disclosed, further comprising receiving a user evaluation of the passenger and storing a result of the evaluation.

In Example 92, the method for ride matching of any one of Examples 48 to 91 is disclosed, further comprising receiving a passenger evaluation of the user and storing a result of the evaluation.

In Example 93, the method for ride matching of Example 91 or 92 is disclosed, further comprising modifying a user factor or based on a result of the evaluation.

In Example 94, the method for ride matching of Example 91 or 92 is disclosed, further comprising modifying a passenger factor or based on a result of the evaluation.

In Example 95, a means for ride matching is disclosed, comprising a storage means configured to store a plurality of vehicle identifiers, each vehicle identifier being associated with a geographic information and a passenger factor of a current or planned passenger; one or more processing means, configured to receive a user ride request comprising a user locational information and a user factor; and select in response to the user ride request a subset of vehicle identifiers based at least on a relationship between a geographic information and the user locational information and on a relationship between the passenger factor and the user factor.

In Example 96, the method for ride matching of Example 95 is disclosed, wherein the vehicle identifiers correspond to autonomous driving vehicles.

In Example 97, the method for ride matching of Example 95 or 96 is disclosed, wherein the geographic information is a current location of a vehicle corresponding to the vehicle identifier.

In Example 98, the method for ride matching of Example 95 or 96 is disclosed, wherein the geographic information is a planned destination of a vehicle corresponding to the vehicle identifier.

In Example 99, the method for ride matching of any one of Examples 95 to 98 is disclosed, wherein the geographic information corresponds to a vehicle route.

In Example 100, the method for ride matching of any one of Examples 95 to 99 is disclosed, wherein the passenger factor is a passenger noise preference.

In Example 101, the method for ride matching of any one of Examples 95 to 99 is disclosed, wherein the passenger factor is a passenger interest.

In Example 102, the method for ride matching of any one of Examples 95 to 99 is disclosed, wherein the passenger factor is a passenger service offered for other passengers.

In Example 103, the method for ride matching of any one of Examples 95 to 99 is disclosed, wherein the passenger factor is a factor associated with a social media account of a passenger.

In Example 104, the method for ride matching of any one of Examples 95 to 99 is disclosed, wherein the passenger factor is a factor associated with a passenger based on one or more prior rides.

In Example 105, the method for ride matching of any one of Examples 95 to 104 is disclosed, wherein the locational information is a user ride origin.

In Example 106, the method for ride matching of any one of Examples 95 to 104 is disclosed, wherein the locational information is a user ride termination.

In Example 107, the method for ride matching of any one of Examples 95 to 104 is disclosed, wherein the locational information comprises a location between a user ride origin and a user ride termination.

In Example 108, the method for ride matching of any one of Examples 95 to 107 is disclosed, wherein the user factor comprises a user noise preference.

In Example 109, the method for ride matching of any one of Examples 95 to 108 is disclosed, wherein the user factor comprises a user interest.

In Example 110, the method for ride matching of any one of Examples 95 to 109 is disclosed, wherein the user factor comprises a passenger service desired.

In Example 111, the method for ride matching of any one of Examples 95 to 110 is disclosed, wherein the user factor comprises a factor associated with a social media account of the user.

In Example 112, the method for ride matching of any one of Examples 95 to 111 is disclosed, wherein the user factor comprises a factor associated with a user based on one or more prior rides.

In Example 113, the method for ride matching of any one of Examples 95 to 112 is disclosed, wherein the storage means is configured as a database.

In Example 114, the method for ride matching of any one of Examples 95 to 113 is disclosed, wherein the user ride request is received from a mobile device.

In Example 115, the method for ride matching of any one of Examples 95 to 114 is disclosed, further comprising a machine learning means, configured to modify a user profile according to a sensor information.

In Example 116, the method for ride matching of Example 115 is disclosed, wherein the machine learning means receives the sensor information from one or more vehicle sensors.

In Example 117, the method for ride matching of Example 115 or 116 is disclosed, wherein the sensor information is determined from a vehicle volume level during the ride.

In Example 118, the method for ride matching of Example 115 or 116 is disclosed, wherein the sensor information is determined from a window position during the ride.

In Example 119, the method for ride matching of Example 115 or 116 is disclosed, wherein the sensor information is determined based on one or more of a seat-belt sensor, a motion detector, or a pressure sensor.

In Example 120, the method for ride matching of Example 115 or 116 is disclosed, wherein the sensor information is obtained from a vehicle camera.

In Example 121, the method for ride matching of Example 120 is disclosed, wherein data from the vehicle camera is processed using facial recognition technology, and the sensor information comprises a recognized facial characteristic.

In Example 122, the method for ride matching of any one of Examples 115 to 121 is disclosed, further comprising selecting the subset based at least on the modified user profile.

In Example 123, the method for ride matching of any one of Examples 95 to 122 is disclosed, further comprising an alert notification means, configured to contact a third-party in response to a ride irregularity.

In Example 124, the method for ride matching of Example 123 is disclosed, wherein the ride irregularity is an unexpected person entering a vehicle with the user.

In Example 125, the method for ride matching of Example 123 is disclosed, wherein the ride irregularity is the user or the passenger exiting the vehicle at an unexpected location.

In Example 126, the method for ride matching of Example 123 is disclosed, wherein the ride irregularity is based on a recognized facial characteristic as determined by a facial recognition technology.

In Example 127, the method for ride matching of any one of Examples 123 to 126 is disclosed, wherein the third-party is any one of an emergency contact of the passenger, an emergency contact of the user, or a police department.

In Example 128, the method for ride matching of any one of Examples 95 to 127 is disclosed, wherein the one or more processing means is further configured to transmit the subset of vehicle identifiers to the user.

In Example 129, the method for ride matching of any one of Examples 95 to 128 is disclosed, wherein the one or more processing means is further configured to transmit information corresponding to the subset of vehicle identifiers to the user.

In Example 130, the method for ride matching of Example 129 is disclosed, wherein the one or more processing means is further configured to receive a user selection of an information corresponding to the subset of vehicle identifiers.

In Example 131, the method for ride matching of any one of Examples 95 to 130 is disclosed, wherein the one or more processing means is further configured to instruct a vehicle corresponding to vehicle identifier within the subset to pick up the user.

In Example 132, the method for ride matching of any one of Examples 95 to 131 is disclosed, wherein the storage means is first configured to store an association of persons who have opted not to ride together is disclosed, wherein the one or more processing means are further configured to eliminate from the subset any vehicle identifier corresponding to a user and passenger associated within the storage means.

In Example 133, the method for ride matching of any one of Examples 95 to 132 is disclosed, wherein the one or more processing means are further configured to cause a user identity information to be sent to the current or planned passenger.

In Example 134, the method for ride matching of Example 133 is disclosed, wherein the one or more processing means are further configured to receive a response from the current or planned passenger, and to eliminate one or more vehicle identifiers from the subset based on the response.

In Example 135, the method for ride matching of any one of Examples 95 to 134 is disclosed, wherein the passenger factor includes an evaluation of the current or planned passenger during a previous ride.

In Example 136, the method for ride matching of any one of Examples 95 to 135 is disclosed, wherein the one or more processing means is further configured to transmit a plurality of potential users for ridesharing to the passenger.

In Example 137, the method for ride matching of Example 136 is disclosed, wherein the one or more processing means is further configured to receive a passenger selection of an information corresponding to the plurality of potential users.

In Example 138, the method for ride matching of any one of Examples 95 to 137 is disclosed, wherein the one or more processing means is further configured to receive a user evaluation of the passenger and store a result of the evaluation.

In Example 139, the method for ride matching of any one of Examples 95 to 138 is disclosed, wherein the one or more processing means is further configured to receive a passenger evaluation of the user and store a result of the evaluation.

In Example 140, the method for ride matching of Example 138 or 139 is disclosed, further comprising modifying a user factor or based on a result of the evaluation.

In Example 141, the method for ride matching of Example 138 or 139 is disclosed, further comprising modifying a passenger factor or based on a result of the evaluation.

In Example 142, a non-transitory computer readable medium configured to carry the method in any one of Examples 48 through 94 is disclosed.

In Example 143, a ride matching system is disclosed comprising: a memory configured to store a plurality of vehicle identifiers, each vehicle identifier being associated with a geographic information and one or more passenger factors of a current or planned passenger; one or more processors, configured to receive a user ride request, the user ride request comprising at least a user locational information and user factor; select a first subset of the plurality of vehicle identifiers in response to the ride request, the selection being made based on a relationship between the first geographic information and the user locational information; select a second subset of the plurality of vehicle identifiers, the second subset being a subset of the first subset, based at least on a relationship between the one or more passenger factors associated with the plurality of vehicle identifiers in the first subset and the user factor.

In Example 144, a ride matching system is disclosed comprising A mobile device, configured to deliver a ride request to a ride matching processor; The ride matching processor comprising a memory configured to store a plurality of vehicle identifiers, each vehicle identifier being associated with a geographic information and a passenger factor of a current or planned passenger; one or more processors, configured to receive a user ride request comprising a user locational information and a user factor; and select in response to the user ride request a subset of vehicle identifiers based at least on a relationship between a geographic information and the user locational information and on a relationship between the passenger factor and the user factor.

In Example 145, the ride matching system of Example 22 is disclosed, wherein the one or more sensors are vehicle sensors.

In Example 146, the ride matching system of Example 22 is disclosed, wherein the one or more sensors are user sensors.

In Example 147, the ride matching system of Example 22 is disclosed, wherein the one or more sensors comprise at least one sensor from the following group: phone sensors, implant sensors, Internet of Things device sensors, and wearable device sensors.

In Example 148, the ride matching system of Example 22 is disclosed, wherein the one or more sensors comprise data obtained from a digital personal assistant.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A ride matching system comprising
a memory configured to store a plurality of vehicle identifiers, each vehicle identifier being associated with a geographic information and a passenger factor of a current or planned passenger;
one or more processors, configured to
receive a user ride request comprising a user locational information and a user factor; and
select in response to the user ride request a subset of vehicle identifiers based at least on a relationship between a geographic information and the user locational information and on a relationship between the passenger factor and the user factor.

2. The ride matching system of claim 1, wherein the vehicle identifiers correspond to autonomous driving vehicles.

3. The ride matching system of claim 1, wherein the geographic information is at least one of a current location of a vehicle corresponding to the vehicle identifier or a planned destination of a vehicle corresponding to the vehicle identifier.

4. The ride matching system of claim 1, wherein the geographic information corresponds to a vehicle route.

5. The ride matching system of claim 1, wherein the passenger factor is at least one of a passenger noise preference; a passenger interest; a passenger service offered for other passengers; a factor associated with a social media account of a passenger; or a factor associated with a passenger based on one or more prior rides.

6. The ride matching system of claim 1, wherein the locational information is at least one of a user ride origin; a user ride termination; or a location between a user ride origin and a user ride termination.

7. The ride matching system of claim 1, wherein the user factor comprises at least one of a user noise preference; a user interest; a passenger service desired; a factor associated with a social media account of the user; or a factor associated with a user based on one or more prior rides.

8. The ride matching system of claim 1, wherein the user ride request is received from a mobile device.

9. The ride matching system of claim 1, further comprising a machine learning circuit, configured to modify a user profile according to a sensor information.

10. The ride matching system of claim 9, wherein the machine learning circuit receives the sensor information from one or more vehicle sensors.

11. The ride matching system of claim 10, wherein the sensor information is determined from at least one of a vehicle volume level during the ride; a window position during the ride; a seat-belt sensor, a motion detector, or a pressure sensor.

12. The ride matching system of claim 10, wherein the sensor information is obtained from a vehicle camera, and wherein data from the vehicle camera is processed using facial recognition technology, and the sensor information comprises a recognized facial characteristic.

13. The ride matching system of claim 1, further comprising an alert circuit, configured to contact a third-party in response to a ride irregularity.

14. The ride matching system of claim 13, wherein the ride irregularity is at least one of an unexpected person entering a vehicle with the user; the user or the passenger exiting the vehicle at an unexpected location, or is based on a recognized facial characteristic as determined by a facial recognition technology.

15. The ride matching system of claim 13, wherein the third-party is any one of an emergency contact of the passenger, an emergency contact of the user, or a police department.

16. The ride matching system of claim 1, wherein the memory is further configured to store an association of persons who have opted not to ride together, wherein the one or more processors are further configured to eliminate from the subset any vehicle identifier corresponding to a user and passenger associated within the memory.

17. A method for ride matching comprising:
storing in a memory a plurality of vehicle identifiers, each vehicle identifier being associated with a geographic information and a passenger factor of a current or planned passenger;
receiving a user ride request comprising a user locational information and a user factor; and
selecting in response to the user ride request a subset of vehicle identifiers based at least on a relationship between a geographic information and the user locational information and on a relationship between the passenger factor and the user factor.

18. The method for ride matching of claim 17, wherein the geographic information is at least one of a current location of a vehicle corresponding to the vehicle identifier; a planned destination of a vehicle corresponding to the vehicle identifier, or where the geographic information corresponds to a vehicle route.

19. The method for ride matching of claim 17, wherein the passenger factor is at least one of a passenger noise preference; a passenger interest; a passenger service offered for other passengers; a factor associated with a social media account of a passenger; or a factor associated with a passenger based on one or more prior rides.

20. The method for ride matching of claim 17, wherein the locational information is at least one of a user ride origin; a user ride termination; or a location between a user ride origin and a user ride termination.
